(19) United States
(12) Patent Application Publication
(10) Pub. No.: US 2005/0276887 A1
(43) Pub. Date: Dec. 15, 2005

(54) Method of marking smoked food products

(76) Inventor: Eberhard Wiedenmann, Leipzig (DE)

Correspondence Address: Collard & Roe, P.C., 177 Northern Boulevard, Roslyn, NY, 11576-1696, US

(21) Appl. No.: 11/149,121

(22) Filed: Jun. 9, 2005

(30) Foreign Application Priority Data
Jun. 9, 2004 (DE) 10 2004 027 901.2
Jan. 7, 2005 (DE) 10 2005 000 953.0

(51) Int. Cl. C12H 1/06

(52) U.S. Cl. 426/237

(57) ABSTRACT

In a process for marking smoked food products 1 by means of a laser beam that is guided under programmed control on the surface of the smoked food product such that the beam tracks the pattern of the mark to be reproduced, the laser beam acts only on the smoked-layer particles located at the surface of the food product, without perceptibly attacking the surface of the food product 1 itself.

The invention relates to a method of marking smoked food products, in particular smoked meat products, with which clearly recognizable lettering or other marks may be reproduced directly on the surface of these food products.

The German laid open print DE 199 51 614 A1 describes a method of marking sausages; according to this method, the surface to be marked is covered prior to smoking with a stencil that reproduces the desired mark. After smoking, the stencil is removed and the mark stands out as a non-smoked (paler) surface area against the smoked (darker), overall surface of the sausage.

This method admittedly permits the reproduction of clearly recognizable marks directly on the sausage. The disadvantage of this method, which necessitates the production and holding in store of stencils, their attachment prior to smoking and their removal after smoking, is that it is very expensive and time-consuming. Moreover, the method is only suitable for the repeated application of the same marks, since any change in the mark inevitably necessitates the fabrication of new, corresponding stencils.

From the patent DE 3 836 821 C3, additionally, a process and a device are known for furnishing food products, preferably cheese, with a surface mark. Here, the bundled thermal energy of a laser beam is used, together with an interposing stencil close to the surface of the food product to be marked, in order to brand a mark, e.g. into the floured wax casing of a cheese. The known method has the disadvantage that the mark is relatively diffuse in appearance because it is formed by flour-particle combustion residues and the relief-like plastic melting of the wax casing. As a result, the process is completely unsuitable for the marking, for example, of sausages with a delicate outer skin. A branding process of this kind would damage the delicate outer skin of, for example, frankfurter or bockwurst sausages to such an extent that the sausages would burst—at the latest when heated in a water bath—and become unusable.

The object of the invention is thus to develop a method of marking smoked food products, which is less expensive and time-consuming than known methods, permits the reproduction of a variety of arbitrarily changeable marks and does not functionally impair the surface of the products to be marked.

The object is established by the characterizing features of claim 1.

Useful embodiments of the method form the features of the sub-claims 2 to 10.

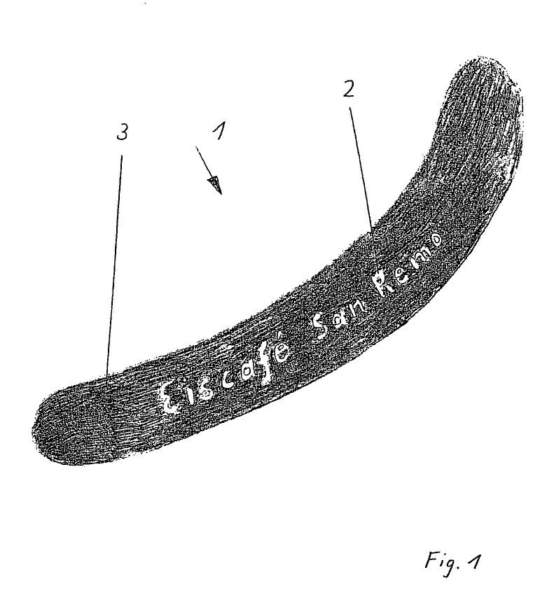

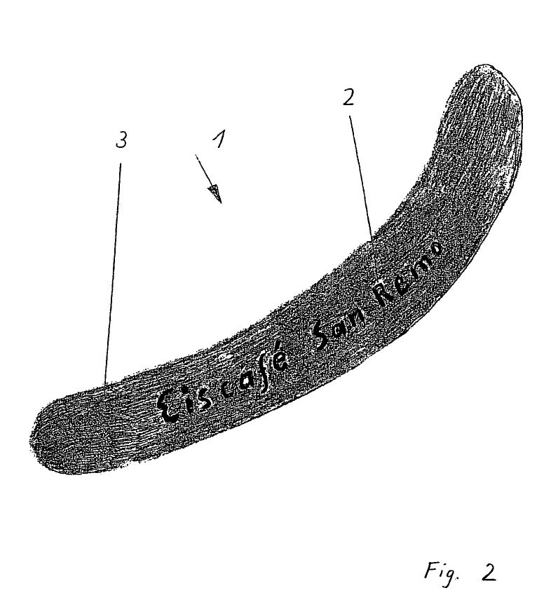

The invention will now be explained in more detail on the basis of a preferred embodiment and by reference to the FIGS. 1 and 2.

FIG. 1 shows, as an example of a smoked food product to be marked, a side view of a bockwurst sausage with a mark according to the invention, the sausage having been marked by way of a first embodiment of the method of the invention.

FIG. 2 shows a side view of a bockwurst sausage that was marked by way of a second embodiment of the method of the invention.

The bockwurst sausage 1 shown in FIG. 1 is smoked in the usual way, as a result of which, on the outside of the casing 3 and firmly adhering thereto, a very thin, darker-coloured smoked layer is formed that gives the sausage an appetizing appearance and the characteristic pleasant taste.

According to a first embodiment of the method of the invention, this very thin smoked layer is removed at the points to be marked—without noticeably damaging the casing—by brief exposure to a program-controlled laser beam. For the duration of exposure to the laser beam, the sausage is grasped by a holding means not illustrated and held with the surface section to be marked in a predetermined plane. The laser beam is moved—by a guide means likewise not illustrated—in the predetermined plane over the surface section to be marked and, with relatively little energy, removes only the particles of the very thin smoked layer that were coloured darker by smoking and are located on the outside of the casing 3, so that the paler casing under the darker smoked layer becomes visible in the pattern of the laser beam movement. The casing is not functionally impaired by the laser beam. The sausages can be heated in a water bath in the usual manner without their bursting and becoming unusable.

According to a second embodiment of the method of the invention, the bockwurst sausage 1 is held in the same way and the particles that were coloured darker by smoking and are located on the outside of the casing are coloured darker still by the energy of a laser beam that is of even lower energy than in the first embodiment. After this action of the laser beam, which is guided according to the pattern of the mark, on the smoked-layer particles, the distinctly darker-coloured mark is clearly visible against the rest of the smoked layer.

The colouring effect produced by the action of the laser beam may be enhanced further by applying a tasteless and water-soluble food-grade contrast medium to the outside surface of the food product before or after smoking. In the case of sausages that are heated in a water bath, the water-soluble contrast medium dissolves in the water bath.

In both embodiments, the movement of the laser beam is program-controlled. This is effected, for example, by entering and storing certain patterns, such as drawings, or lettering in the memory of a computer. The information stored in the computer can then be called up to guide the movements of the laser beam in the predetermined plane over the surface section 1, so that the smoked layer is removed or darkened according to the pattern of the stored information. There is ultimately the additional possibility of alternating, within a single operation, between removal and darkening mode, and thus of applying two-tone patterns.

Thanks to the program-controlled application of marks, it is no problem at all to furnish smoked food products such as the bockwurst sausages illustrated in FIGS. 1 and 2 with a wide variety of pictures or lettering, to switch constantly among marks and to continually introduce new marks. Not only publicity marks of the kind shown in FIGS. 1 and 2 may be applied in this way: special, personalized guest wishes, too, such as names or greetings, or animal or fairy-tale figures for children, can be fulfilled in just a few minutes.

Marks are entered into the computer using input devices such as keyboards, scanners, graphic tablets, light pens, etc. This can also be done by way of teletransmission.

Grasping of the food product by the holding means and orientation of the surface section to be marked in the predetermined plane is preferably effected automatically. Since the smoked food products are natural products without an ideal geometrical form (e.g. the sausages 1 shown in FIGS. 1 and 2 are curved to a greater or lesser extent) and do not form an exactly planar surface in space, the laser beam can be controlled advantageously by sensors and made to track along the areas to be marked, while the laser beam's plane of action can be precisely determined and controlled by autofocus.

The method of the invention requires no material- or labour-intensive stencils with which, until now, only certain marks could be applied.

Unlike the known marking processes, in which marking was effected by way of branding with laser beams, thus distorting and damaging the surface of the food product, the method of the invention makes it possible to mark even very delicate food products, for example, delicate natural sausage casings, that inevitably would be damaged and rendered unusable if the known laser method were applied.

By virtue of the fact that the mark to be applied can be entered and stored electronically, and that the laser beam can be guided automatically under programmed control on the section of the food product's surface that is to be marked, the method of the invention is extremely versatile and permits a wide variety of marks to be applied on the smoked surfaces of the food products within a very short time.

1. Method of marking smoked food products (1) using a laser beam that is guided under programmed control on the surface of the smoked food product such that the beam traces the pattern of the mark to be reproduced,
wherein
the laser beam acts only on the colour-conferring smoked particles located at the surface of the food product, in the pattern of the mark to be reproduced, without perceptibly attacking the surface itself.

2. Method according to claim 1,
wherein
the laser beam removes the colour-conferring smoked particles located on the surface of the food product according to the pattern of the mark to be reproduced.

3. Method according to claim 1,
wherein
the laser beam darkens the colour-conferring smoked particles located at the surface of the food product.

4. Method according to claim 1,
wherein
the laser beam partially removes and partially darkens the colour-conferring smoked particles located at the surface of the food product according to the pattern of the mark to be reproduced, thus generating a two-tone mark.

5. Method according to claim 1,
wherein
a tasteless and water-soluble food-grade contrast medium is applied to the surface of the food product either before or after smoking.

6. Method according to claim 1,
wherein
the food product to be marked is grasped by a holding means and held with the surface section to be marked in a predetermined plane.

7. Method according claim 1,
wherein
the section of the smoked food product's surface that is to be marked is registered by sensors and the laser beam moved such that it tracks this surface section.

8. Method according claim 1,
wherein
the laser beam's action plane on the smoked food product is determined and adjusted by autofocus.

9. Method according claim 1,
wherein
the marks to be reproduced are entered and stored in a computer, and are called up to control the laser beam.

10. Method according to claim 8,
wherein
the marks are entered by way of input devices such as keyboards, scanners, graphic tablets, light pens, etc.

11. Method according to claim 8,
wherein
the marks are entered into the computer by way of teletransmission.
